(19) United States
(12) Patent Application Publication
(10) Pub. No.: US 2002/0033884 A1
(43) Pub. Date: Mar. 21, 2002

(54) Machine vision-based sorter verification

(76) Inventor: George W. Schurr, Fort Thomas, KY (US)

Correspondence Address: Bourque & Associates, P.A., 835 Hanover Street, Suite 303, Manchester, NH, 03104, US

(21) Appl. No.: 09/837,696

(22) Filed: Apr. 18, 2001

Related U.S. Application Data
(60) Provisional application No. 60/201,406, filed on May 3, 2000.

(51) Int. Cl. H04N 7/18

(52) U.S. Cl. 348/127

(57) ABSTRACT

A system and method for detecting objects in a tray door of an automatic sorter machine. The system includes at least one machine vision camera, at least one illumination subsystem and at least one machine vision computer. The illumination subsystem is configured to illuminate a tray door, e.g., using a plurality of lines, as it is conveyed past at least one field of view at an inspection station within the sorter machine. Each camera is positioned to capture one or more images of the tray doors while in the field of view. Each computer is programmed to detect the presence of objects by detecting and counting the number of lines appearing in the captured image(s). If the number of lines are less than an expected number, are shorter than an expected length, or appear to be bent, an object detection condition is asserted.

### CROSS-REFERENCE TO RELATED APPLICATIONS

The present application claims the benefit of U.S. Provisional Application Serial No. 60/201,406 filed May 3, 2000, which is fully incorporated herein by reference.

### FIELD OF THE INVENTION

The present invention relates to inspection systems and methods and in particular, to a system and method for detecting packages/objects in sorter trays for distribution systems.

### BACKGROUND OF THE INVENTION

Digital data and signal processing techniques and vision system technology have tremendously advanced the ability to use such hardware and software as data processing systems to accomplish sophisticated inspection procedures without human intervention. Almost every type of product can benefit from low cost, high precision, high speed, inspection technology derived from these new digital data and signal processing techniques.

One such situation that has greatly benefited from high speed inspection technology involves material sorting systems. In one such system, packaged individual retail clothing items are hand tossed onto an automatic sorter for order fulfillment to retail outlets. The presence of the item needs to be electronically verified so that the automatic sorter can deposit the item from the identified sorter tray into the correct shipping container for a particular store. In the industry, package trays sometimes operate by dropping the package/object downward much like an airplane bomb bay door. Therefore, such term will be utilized herein. In this way, automated systems can duplicate tasks that were previously performed by humans, such as sorting items according to destination locations. However, in order for such automated sorting apparatus to operate efficiently and effectively, the sorting system must know which trays/bomb bay doors have items on them and it must be able to discriminate those items from stray labels, tags and debris that may be left in and on the tray/bomb bay door. As can be appreciated, errors incur additional costs in shipping and time.

Accordingly, it would be advantageous to provide a system and method of identifying empty vs. loaded trays/bomb bay doors. Advantageously, such a system would be automated such that a loaded or “picked” tray/bomb bay door would be detected.

### SUMMARY OF THE INVENTION

The present invention provides a system and method for detecting the presence of objects on a moving tray door at an inspection station of a sorter machine. The machine vision system includes at least one illumination subsystem, at least one machine vision camera, and at least one machine vision computer. Each illumination subsystem includes a structured laser line source configured to illuminate the tray door with a plurality of laser lines as the tray door is conveyed past a field of view at the inspection station of the sorter machine. Each camera is positioned to capture at least one image of the tray door as it is being illuminated within the field of view. Each machine vision computer is programmed to detect the presence of one or more objects on the tray door by detecting and counting a number of laser lines appearing in the image of the tray door captured by the camera.

The structured laser line source preferably comprises a pulsed laser line generator, which pulses the laser lines with a variable duration. This prevents blurring in the image caused by the motion of the tray door. One preferred embodiment of the illumination subsystem includes a laser pulse controller, connected to the computer, for receiving a strobe signal from the computer and for generating a pulse output signal. A laser including line generating optics is connected to the laser pulse controller. The laser receives the pulse output signal from the laser pulse controller, for generating pulsed laser lines. One embodiment of the laser pulse controller includes a pulse width selector.

The longitudinal axes of the camera and laser line source preferably form an angle in the range of about 15 to 45 degrees with respect to each other. The angular relationship allows the system to image the 3 dimensional contours of an object in a substantially flat tray door.

The present invention also provides a method of detecting the presence of an object on a tray door being conveyed through a field of view of an inspection station. The method comprises illuminating one tray door with a plurality of lines as it passes through the field of view. While the tray door is illuminated, at least one image of the tray door is captured and a number of lines appearing in the captured image is counted. The number of lines counted in the captured image is compared with an expected number of lines, and an object detected condition is asserted if the number of lines counted differs from the expected number of lines. This method detects the presence of valid objects without erroneously detecting tags, labels, and the like.

According to one preferred method, sections of the captured image(s) are windowed using a region of interest (ROI). Within these ROI's, blob processing is used to count the lines appearing in the ROI. The blob processing is implemented with a size filter to eliminate any objects smaller than a specified size limit, for example a 1 inch by 1 inch area. If more or less lines are counted within the ROI, then an object detected condition is asserted. In addition the vertical extent (length) of each line is checked and any lines shorter than a specified limit will cause an object detected condition to be asserted. This second step handles boundary conditions where the object may have just touched the end of a laser line but does not break or deform it significantly.

In one method, each image or ROI is processed using a filter, such as a Sobel filter, which extracts the horizontal edge component of the image. This step serves to detect lines that are bent, due to the presence of an object with some height.

### DESCRIPTION OF THE DRAWINGS

These and other claims of the present invention will be more fully understood when reading the detailed description taken together with the drawings wherein:

FIG. 1 is a block diagram showing the major functional components of a system for detecting objects in a tray/bomb bay door, according to the present invention;

FIG. 2 is a perspective view of a sorter tray being imaged by the system of FIG. 1, showing the relative positions of the illumination subsystem and image capture devices;

FIG. 3 is an electrical block diagram of the laser pulse controller of FIG. 1;

FIG. 4 is a flow diagram showing a method of detecting objects in a tray/bomb bay door, according to the present invention;

FIG. 5 is an image of an empty tray/bomb bay door with the laser lines projected in it;

FIG. 6 is an image of a tray/bomb bay door with an object in it;

FIG. 7 is an image of a tray/bomb bay door with a larger object in it;

FIG. 8 is an image of a tray/bomb bay door showing a plurality of ROI's that are used to surround the blobs appearing in the image, according to one method of the present invention; and

FIG. 9 is an image of the horizontal Sobel gradient components being processed using blob analysis, according to one method of the present invention.

### DESCRIPTION OF THE INVENTION

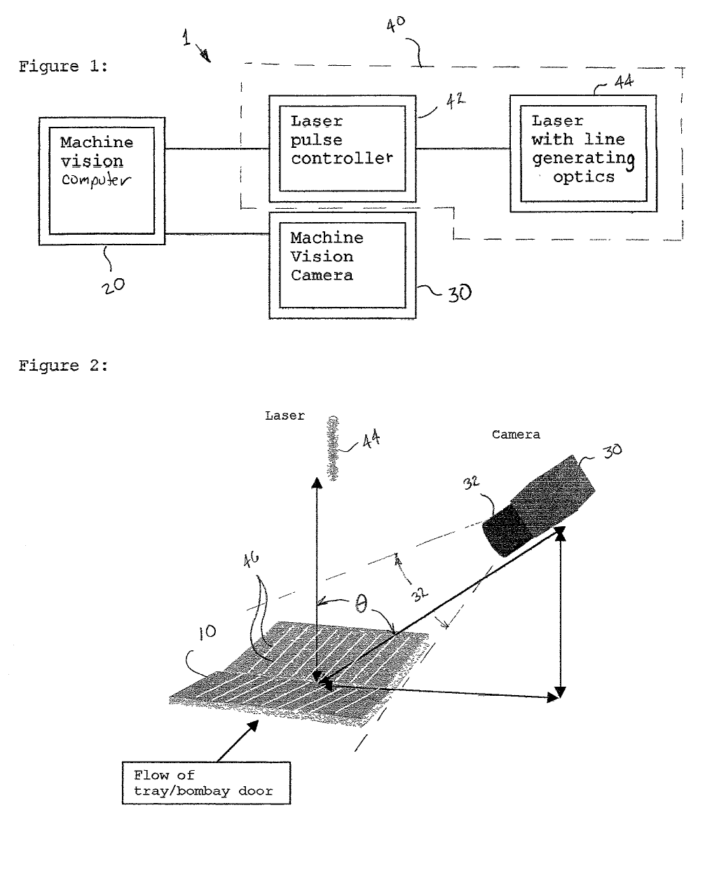

Turning now to the figures and, in particular, FIGS. 1-3, a system 1 for detecting the presence of objects within or on a tray/bomb bay door 10 is shown. The system 1 includes at least one machine vision computer 20, at least one machine vision camera 30 such as CCD camera configured to capture at least one image of the tray/bomb bay door 10, and at least one illumination subsystem 40 configured to illuminate the tray/bomb bay door 10 as it passes through a field of view 32.

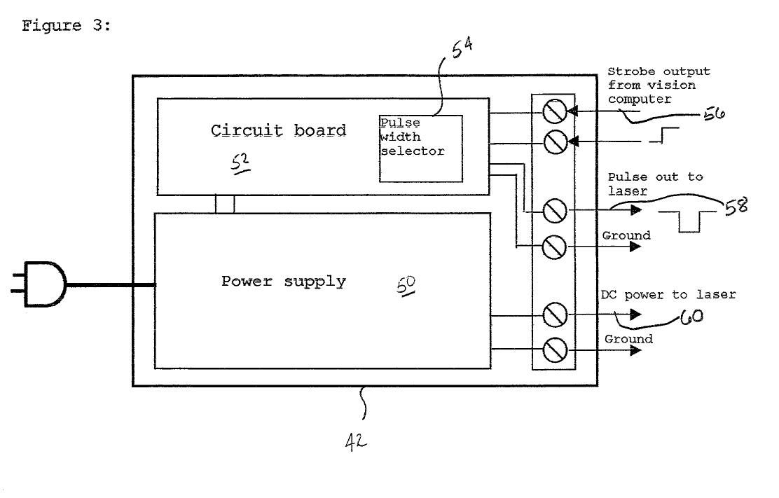

In one preferred embodiment, the illumination subsystem 40 includes a structured laser line source, which is made up of a laser pulse controller 42 and a laser with line generating optics 44, which images, onto the tray/bomb bay door, a plurality of laser lines 46 arranged in a substantially parallel fashion. The laser pulse controller 42 (FIG. 3) includes a power supply 50 and a circuit board 52, including a pulse width selector 54 for receiving a strobe output 56 from the machine vision computer 20 and for providing a synchronized pulse output 58 to the laser 44, as well as laser operating power 60. The use of a pulsed laser line generator illuminates a tray/bomb bay door with laser lines having a variable duration to prevent blurring in the image caused by the motion of the tray/bomb bay door.

The number of laser lines used determines the size of the smallest detectable object. The use of structured laser line illumination makes it possible to detect objects that have height (e.g. retail purchased items) vs. objects that have little or no height, such as labels and bar code tags. The camera 30 and laser 44 (FIG. 2) are positioned at an angle θ of substantially between 15 and 45 degrees with respect to each other. The angular relationship allows the system to image the 3-dimensional contours of an object in the predominantly flat tray/bomb bay door 10. The camera(s) 30 is equipped with an optical band pass filter 32 selected to pass the laser line frequency and block other light frequencies from ambient sources.

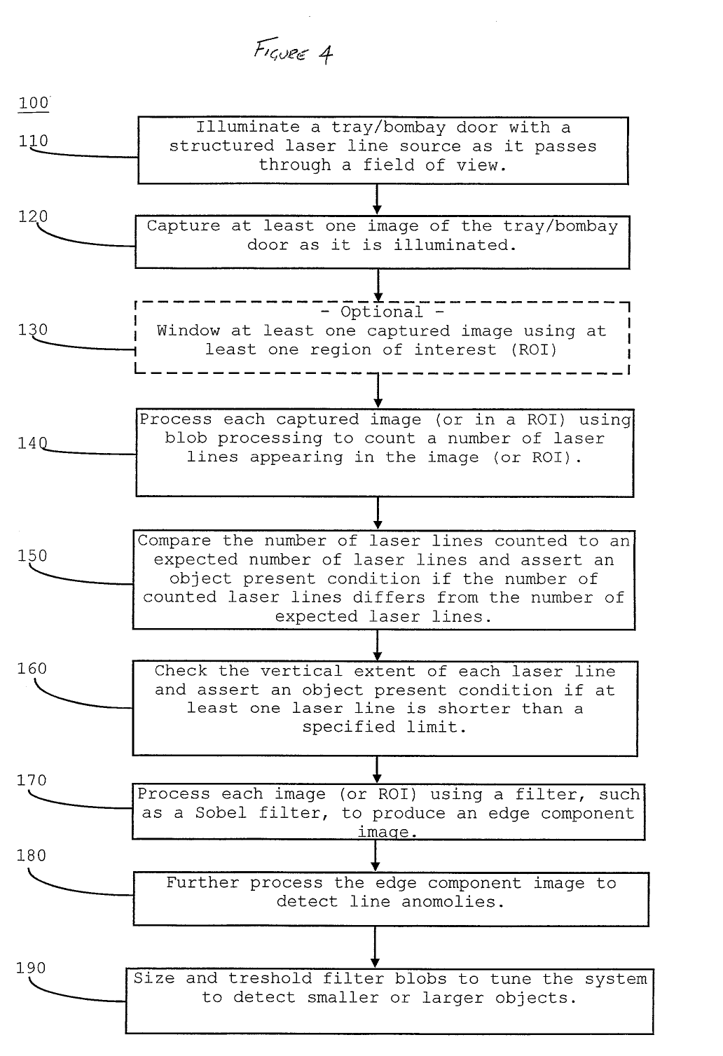

The method 100 (FIG. 4) of the present invention begins by illuminating one tray/bomb bay door with a structured laser line source as it passes through a field of view, step 110. While the tray/bomb bay door is illuminated, at least one image of the tray/bomb bay door is captured by at least one of the machine vision cameras, step 120.

Once captured, sections of the captured image(s) are preferably windowed using a region of interest (ROI), step 130, although this step is optional. Within these ROI's blob processing is used to count the laser lines appearing in the ROI, step 140. The blob processing is preferably implemented using a size filter to eliminate any objects smaller than a specified size limit, for example a 1 inch by 1 inch area. If a number of laser lines appearing in a ROI is greater than or less than the expected number of laser lines, then an object detected condition is asserted, step 150. In addition, in step 160, the vertical extent (length) of the each laser line is checked and any laser lines shorter than a specified limit will cause an object detected condition to be asserted. This step handles boundary conditions where the object may have just touched the end of the laser line but does not break or deform it significantly.

Next, in step 170, each ROI is processed using a filter, such as a Sobel filter, to extract the horizontal edge component of the image. This step serves to detect laser lines that are bent, due to the presence of an object with some height. Any line that is bent and deviates from a straight vertical line will have some horizontal edge component. This horizontal edge component image is further processed with blob processing to detect those line anomalies, step 180. Finally, in step 190, the blobs can be size and threshold filtered to tune the system to detect smaller or larger objects. If an object is detected, then the appropriate condition is asserted.

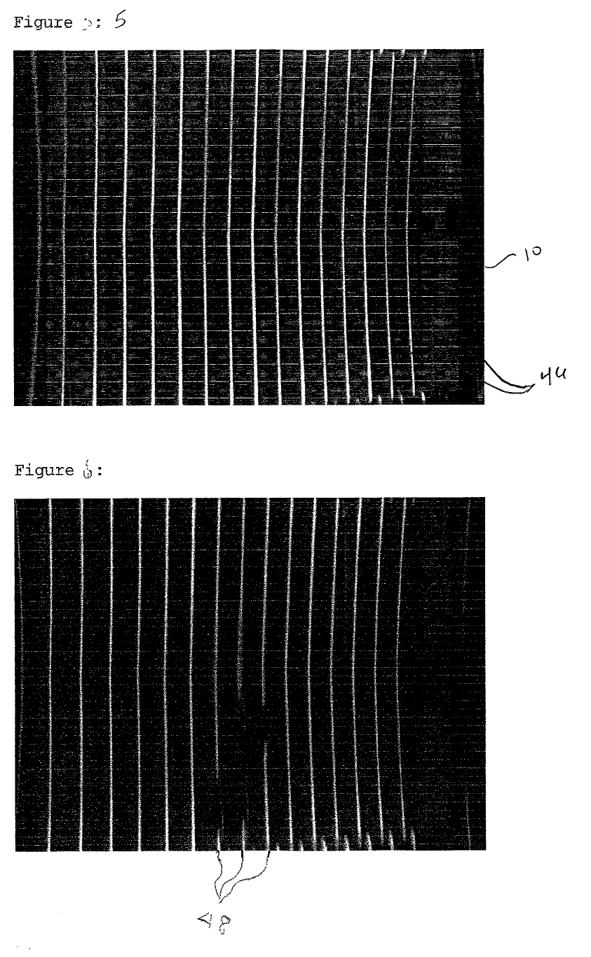

FIGS. 5-9 show images of laser lines illuminating a tray/bomb bay door according to the present invention. For example, FIG. 5 shows an image of an empty tray/bomb bay door 10 illuminated by a plurality of laser lines 46. In FIG. 6, a tray/bomb bay door 10 that contains an object is being illuminated by a structured laser line source according to the present invention. As can be seen, the plurality of laser lines 48 projected onto the tray/bomb bay door containing the object are broken, which is indicative of an object present condition.

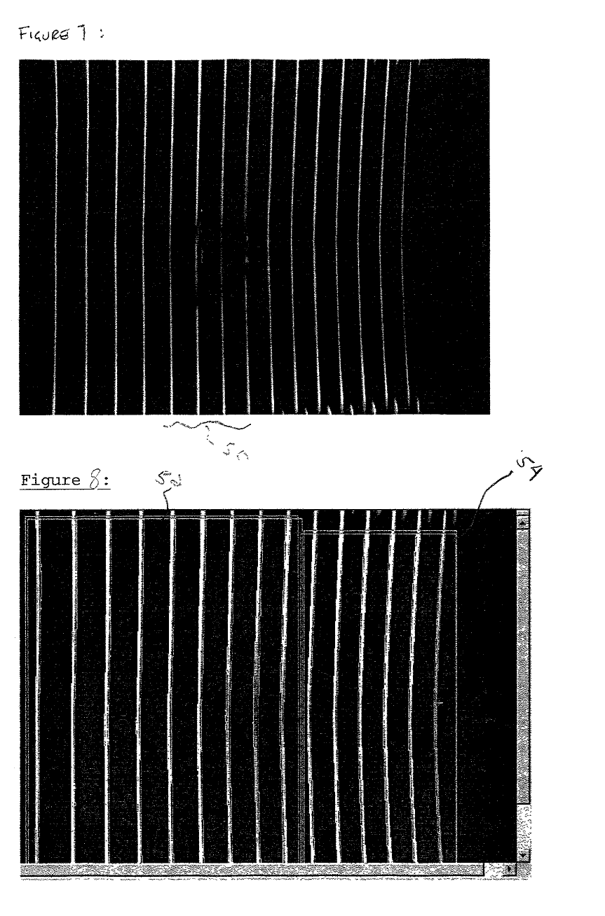

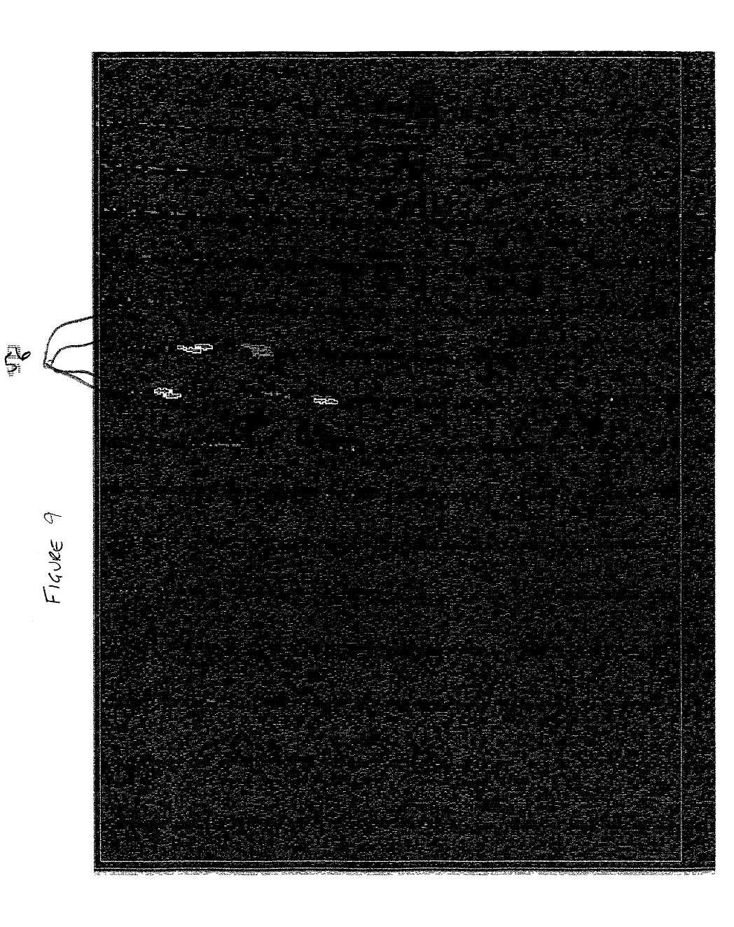

FIG. 7 is an image of a tray/bomb bay door containing a large object. As can be seen, the large object creates laser line discontinuities as well as laser line deflections and deviations in laser lines 50. FIG. 8 is an image of a tray/bomb bay door showing a plurality of ROI's 52, 54 that are used to surround blobs appearing in the image. Finally, in FIG. 9, an image of a tray/bomb bay door's horizontal Sobel gradient components 56 is shown, after the image is processed using blob analysis according to the teachings of the present invention.

Accordingly, the present invention teaches a new and useful system and method for detecting the presence of objects in a substantially flat tray/bomb bay door. Of course, modifications and substitutions by one ordinary skill in the art are considered to be within the scope of the present invention.

The invention claimed is:

1. A machine vision system for detecting the presence of objects on a moving tray door at an inspection station of a sorter machine, said system comprising:
at least one illumination subsystem including a structured laser line source configured to illuminate said tray door with a plurality of laser lines as said tray door is conveyed past a field of view at said inspection station on said sorter machine;
at least one camera positioned to capture at least one image of said tray door as said tray door is illuminated within said field of view; and
at least one machine vision computer programmed to detect the presence of at least one object on the tray door by detecting and counting a number of laser lines appearing in an image of said tray door captured by said at least one camera.

2. The machine vision system of claim 1, wherein said structured laser line source comprises a pulsed laser line generator which pulses said laser lines with a variable duration.

3. The machine vision system of claim 2, wherein said illumination subsystem includes a laser pulse controller, electrically connected to said machine vision computer, for controlling said pulsed laser line generator.

4. The machine vision system of claim 1 wherein said illumination subsystem includes:
a laser pulse controller, connected to said computer, for receiving a strobe signal from said computer and for generating a pulse output signal; and
a laser connected to said laser pulse controller, wherein said laser includes line generating optics, and wherein said laser receives said pulse output signal from said laser pulse controller, for generating pulsed laser lines.

5. The machine vision system of claim 4 wherein said laser pulse controller includes a pulse width selector.

6. The machine vision system of claim 1 wherein longitudinal axes of said camera and said laser line source form an angle in the range of about 15° to 45°.

7. A method of detecting the presence of an object on a tray door being conveyed through a field of view of an inspection station, said method comprising:
illuminating one tray door with a plurality of lines as said tray door passes through said field of view;
capturing at least one image of said tray door while said tray door is illuminated within said field of view;
counting a number of lines appearing in said at least one captured image;
comparing said number of lines counted in said at least one captured image with an expected number of lines; and
asserting an object detected condition if said number of lines counted differs from said expected number of lines.

8. The method of claim 7 further including windowing said at least one captured image using at least one region of interest (ROI), and wherein said step of counting said number of lines comprises counting said number of lines appearing in said at least one ROI.

9. The method of claim 7, wherein blob processing is used to count the number of lines appearing in said at least one captured image.

10. The method of claim 9, wherein said blob processing step is implemented using a size filter to eliminate any objects smaller than a specified size limit.

11. The method of claim 9, further comprising the step of checking the vertical extent of each line, wherein said object detected condition is asserted if any lines are present in said captured image that are shorter than a specified limit.

12. The method of claim 7, further comprising the step of processing said at least one captured image using at least one filter to detect lines that are bent, due to the presence of an object having some height.

13. The method of claim 12, wherein said at least one filter comprises a Sobel filter.

14. The method of claim 7, further including pulsing said lines illuminated on said tray door.

15. A method of detecting the presence of an object on a tray door being conveyed through a field of view of an inspection station, said method comprising:
illuminating one tray door with a plurality of laser lines as said tray door passes through said field of view;
pulsing said laser lines with a variable duration signal;
capturing at least one image of said tray door while said tray door is illuminated within said field of view;
counting a number of lines appearing in said at least one captured image;
comparing said number of lines counted in said at least one captured image with an expected number of lines; and
asserting an object detected condition if said number of lines counted differs from said expected number of lines.

16. The method of claim 15 wherein said tray door is illuminated by a laser, wherein said image is captured by a camera, and wherein longitudinal axes of said camera and said laser form an angle in the range of about 15° to 45°.

17. The method of claim 15 further comprising forming a window around at least one region of interest (ROI) in said image, and wherein said number of lines are counted within said at least one ROI.

18. The method of claim 17 wherein counting said number of lines is performed by blob processing within said at least one ROI.

19. The method of claim 17 further comprising processing each said at least one ROI with a Sobel filter to extract a horizontal edge component in said image.

20. The method of claim 17 further comprising:
checking a vertical extent of said lines in said image; and
asserting an object detected condition if any of said lines is shorter than a specified limit.
